(19) United States
(12) Patent Application Publication
(10) Pub. No.: US 2015/0065257 A1
(43) Pub. Date: Mar. 5, 2015

(54) SYSTEM AND METHOD FOR TIERED INDIVIDUAL PLAYER DRAFT FOR FANTASY SPORTS

(71) Applicant: SODRAFT SPORTS MEDIA, INC., Vancouver (CA)

(72) Inventor: Krishna Jolliffe, Vancouver (CA)

(21) Appl. No.: 14/382,189

(22) PCT Filed: Mar. 1, 2013
(86) PCT No.: PCT/CA2013/050158

§ 371 Date: Aug. 29, 2014

Related U.S. Application Data
(60) Provisional application No. 61/605,972, filed on Mar. 2, 2012.

(51) Int. Cl. A63F 13/828

(52) U.S. Cl. CPC A63F 13/828
USPC 463/43

(57) ABSTRACT

A method of drafting one or more players in a fantasy sport includes: providing a user with a tiered list of players available for drafting for a player squad, each available player having a ranking in first, second or third tiers; receiving a first selection of a player for the player squad from the first tier; determining a subset of the second tier of players available to the user for drafting in the second tier, based on the first selection; receiving a second selection of a player for the player squad from the second tier subset; determining a subset of the third tier of players available to the user for drafting in the third tier, based on the first and second selections; receiving a third selection of a player for the player squad from the third tier subset; and storing the selections of players for the player squad.

### 1. TECHNICAL FIELD

The present invention relates generally to a systems and methods for playing fantasy sports games. More specifically, the present invention relates to a system and method for providing a tiered individual draft or selection of players for a fantasy sports game.

### 2. BACKGROUND OF THE INVENTION

Fantasy sports games typically include competitions among leagues or groups of individuals by which individual participants can simulate ownership and management of a sports team including the making of team management decisions such as player selection or drafting, call-up and benching of backup players, and trading of players, for example. In known fantasy sports leagues or competitions, users can own and manage simulated sports teams in a variety of team sports including, but not limited to American football, basketball, baseball, soccer, hockey, cricket, Australian football and rugby, for example.

In conventional fantasy sports leagues, each player in a user's simulated team is awarded fantasy points and the overall total points accumulated by players on a user's team is used to determine the winner of a fantasy sports competition or league between multiple users. The fantasy sports points awarded to players on users' simulated teams are typically based on the player's performance in a real-world professional sports leagues proceeding during the same timeframe as the fantasy sports competition, as determined by a variety of commonly used player performance statistics, which are dependent on the fantasy sport involved.

In order for fantasy sports users to select a group of players to their simulated team that will generate a desired maximum number of fantasy points, users participate in a draft process or sequence to simulate selection of players in real-world sports teams, and also to ensure fairness of opportunity for selection of players between fantasy sports users. Fantasy sports users will attempt to user their understanding of fundamentals of the fantasy sport game, individual player characteristics, and expectations for player performance to draft a group of players during the fantasy sports draft that will give a maximum chance of winning by accumulating the most fantasy points for their simulated team. Therefore, selection of the players to a user's team through the fantasy sports draft (hereafter referred to as drafting) plays an important part in determining the success of a fantasy sports user in their fantasy competition or league.

Typically, fantasy sports leagues or competitions have allowed drafting of players according to one of two traditional methods, either a serpentine draft where users in a league take turns drafting players in a serpentine method where the user picking first one round then picks last in the next round, or an auction draft where users are given an imaginary budget for drafting players, and players are nominated in turns for bidding. In the bidding for each player, the user bidding highest will add that player to their simulated team and have their winning bid subtracted from their budget available for bidding for subsequent players. In some cases, a few conventional fantasy leagues have also used a hybrid of serpentine and auction drafting methods, where a portion of the players are selected by auction, and remainder selected by a serpentine method.

In conventional fantasy sports leagues or competitions, the requirement of all users participating in the league or competition to be in communication at one time for the draft to proceed by either of the traditional drafting methods, and the limitation of the number of desirable and highly enough ranked players available for drafting to user's simulated teams, has led to a practical requirement to strictly limit the number of users in a league or competition. In the vast majority of fantasy sports leagues or competitions, the limit to number of users that can participate is typically 12. Therefore, using traditional fantasy sports drafting methods, it is not feasible to provide for leagues or competitions where large or unlimited numbers of users may compete against each other in the same competition at the same time.

Accordingly, in view of the above, a need exists for a system and method to provide a tiered individual draft or selection of players for a fantasy sports game that may desirably accommodate large numbers of players in one competition simultaneously.

### 3. SUMMARY OF THE INVENTION

It is an object of the present invention to provide a system and method for a tiered individual draft of players for a fantasy sports game that addresses some of the limitations of the prior art.

Another object of the present invention is to provide a system comprising a computer-readable memory module comprising computer-readable instructions for providing a tiered individual draft of players for a fantasy sport game that addresses some of the limitations of the prior art.

Yet another object of the present invention is to provide a method for a tiered individual draft of players for a fantasy sports game comprising a game board and game elements representing players to be drafted, that addresses some of the limitations of the prior art.

It is a further object of the invention to provide a tangible, non-transitory computer-readable storage medium comprising computer-readable instructions for providing a tiered individual draft of players for a fantasy sport game that addresses some of the limitations of the prior art.

According to an embodiment of the invention, a method of drafting one or more players in a fantasy sport is provided, the method comprising: providing a user with a tiered list of available players available for drafting to the user's fantasy team for a player squad, each available player having an associated ranking in a first, second or third tier of the tiered list; receiving a first selection of a first available player for the player squad from the first tier of available players; determining a subset of the second tier of available players available to the user for drafting in the second tier, based on the first selection; receiving a second selection of a second available player for the player squad from the subset of the second tier of available players; determining a subset of the third tier of available players available to the user for drafting in the third tier, based on the first and second selections; receiving a third selection of a second available player for the player squad from the subset of the third tier of available players; and storing the first, second and third selections of players for the player squad. In one such embodiment, a player squad may comprise a group of players of a fantasy sport associated with or who play at a particular position or group of positions in a fantasy sport.

According to another embodiment of the invention, a tangible, non-transitory computer-readable medium encoded with computer-executable instructions for drafting one or more players in a fantasy sport is provided. In such an embodiment, the computer-executable instructions, when executed, are operable to cause at least one processor to: provide a user with a tiered list of available players available for drafting to the user's fantasy team for a player squad, each available player having an associated ranking in a first, second or third tier of the tiered list; receive a first selection of a first available player for the first player squad from the first tier of available players; determine a subset of the second tier of available players available to the user for drafting in the second tier, based on the first selection; receive a second selection of a second available player for the player squad from the subset of the second tier of available players; determine a subset of the third tier of available players available to the user for drafting in the third tier, based on the first and second selections; receive a third selection of a second available player for the player squad from the subset of the third tier of available players; and store the first, second and third selections of players for the player squad.

According to a further embodiment of the invention, a system for drafting one or more players in a fantasy sport is provided. In such an embodiment, the system comprises: one or more network interfaces; at least one processor; a computer-readable memory module; and computer-readable instructions stored in the computer-readable memory module, wherein the computer-readable instructions when executed, are operable to cause the at least one processor to: provide a user with a tiered list of available players available for drafting to the user's fantasy team for a player squad, each available player having an associated ranking in a first, second or third tier of the tiered list; receive a first selection of a first available player for the first player squad from the first tier of available players; determine a subset of the second tier of available players available to the user for drafting in the second tier, based on the first selection; receive a second selection of a second available player for the player squad from the subset of the second tier of available players; determine a subset of the third tier of available players available to the user for drafting in the third tier, based on the first and second selections; receive a third selection of a second available player for the player squad from the subset of the third tier of available players; and store the first, second and third selections of players for the player squad.

Further advantages of the invention will become apparent when considering the drawings in conjunction with the detailed description.

### 4. BRIEF DESCRIPTION OF THE DRAWINGS

The system and method of the present invention will now be described with reference to the accompanying drawing figures, in which:

FIG. 1 illustrates a functional block diagram of an exemplary network environment for implementing a computer-implemented embodiment of the present invention.

FIG. 2 illustrates a functional block diagram of an exemplary user device architecture configured according to an embodiment of the invention.

FIG. 3 illustrates a functional block diagram of an exemplary fantasy sport draft server architecture configured according to an embodiment of the invention.

FIG. 4 illustrates an exemplary series of operations associated with an embodiment of the invention.

FIG. 5 illustrates an exemplary series of operations associated with a further embodiment of the invention.

FIG. 6 illustrates an exemplary tiered draft selection tree, showing a plurality of potential selection paths for drafting players in a fantasy sport game according to an embodiment of the invention.

Like reference numerals refer to corresponding parts throughout the several views of the drawings.

### 5. DETAILED DESCRIPTION OF THE INVENTION

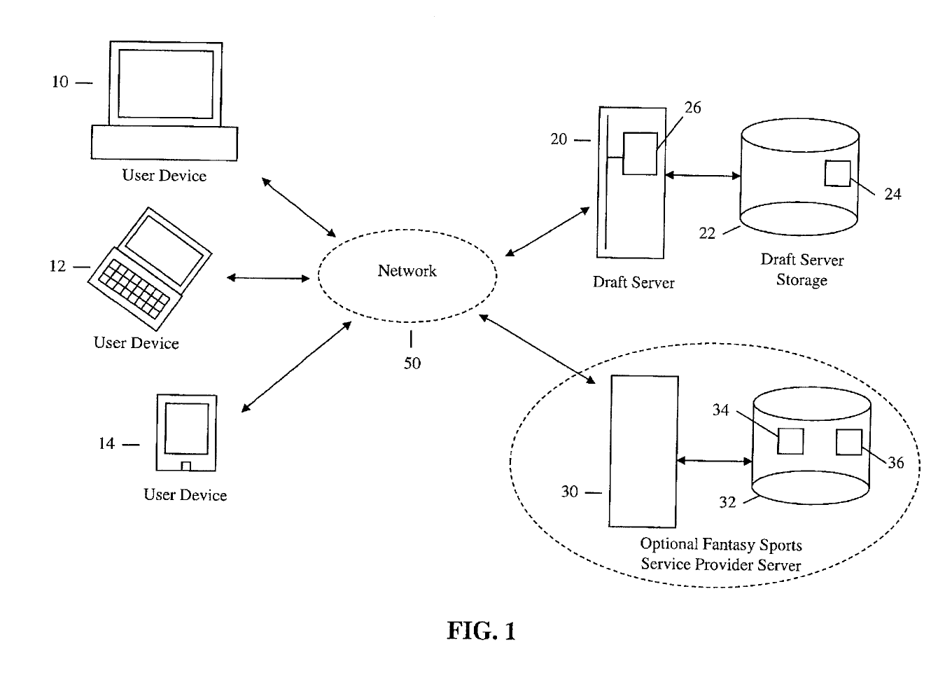

FIG. 1 illustrates a functional block diagram of an exemplary network environment in which computer implemented embodiments of the present invention may be implemented. The networked environment includes one or more user computing devices 10, 12, 14 connected to a communication network 50, which may include one or more of: a local area network, wide area network, world wide web (WWW), or the global Internet, for example, such that user device 10 may communicate with other computers and/or computing devices similarly connected to network 50. Other computers connected to network 50 may include a fantasy sports draft server 20, and optional fantasy sports service provider server 30, which may each communicate with any other computer connected to the network 50. User computing devices 10, 12, 14 include standard computing components for transmitting and receiving data to and from other computers connected to the user computing devices 10, 12, 14 through network 50. In one embodiment of the invention, user computing devices 10, 12, 14 may comprise one or more of a: personal computing device such as a desktop computer or terminal 10, a mobile computing device such as a notebook, laptop, netbook or palmtop computer or smartphone device 12, and a touchscreen computing device such as a smartphone, tablet or media player computing device 14, for example.

Fantasy draft server 20 includes standard computing components for transmitting and receiving data to and from other computers and/or computing devices connected over the network 50, including user devices 10, 12, 14, and optionally also fantasy sports service provider server 30. In particular, fantasy draft server 20 includes or is connected to at least one draft server storage repository 22 for storing data which may be transmitted or received to or from other computers or computing devices. Such storage repository may comprise a conventional data storage device such as a hard disk or solid-state memory located with and connected directly to fantasy sports draft server 20, or may alternatively comprise a remote data storage repository connected to fantasy sports draft server 20, such as a network storage appliance or separate storage server, or cloud storage service provider, for example.

In one embodiment, fantasy draft server 20 may comprise at least one computer readable memory module 26, which may store computer readable instructions or code for implementing functions of the invention, for example. In another embodiment, fantasy draft server storage repository 22 may comprise at least one computer readable memory module 24 storing at least one of: computer readable instructions or code for implementing functions of the invention; and data transmitted to and/or received from other computers, such as user data corresponding to one or more fantasy sports user, player data corresponding to one or more fantasy sport players, and system data corresponding to one or more system function, for example. In one such embodiment, system data may comprise at least one of data corresponding to a fantasy sports game, and data corresponding to operation of the system such as control, statistical, advertising or commercial data, for example. In an alternative embodiment, such as may be particularly adapted for a small network of devices, draft server 20 may comprise a user device such as user device 10, 12 or 14, for example, which may implement the functions and components of a draft server 20.

In an optional embodiment of the present invention, optional fantasy sports service provider server 30 also includes standard computing components for transmitting and receiving data to and from other computers and/or computing devices connected over the network 50, including user devices 10, 12, 14, and fantasy sports draft server 20. In particular, fantasy sports service provider server 30 includes or is connected to at least one service provider storage repository 32 for storing data which may be transmitted or received to or from other computers or computing devices. Such storage repository may comprise a conventional data storage device such as a hard disk or solid-state memory located with and connected directly to fantasy sports service provider server 30, or may alternatively comprise a remote data storage repository 32 connected to fantasy sports service provider server 30, such as a network storage appliance or separate storage server, or cloud storage service provider, for example.

In one embodiment, fantasy sports service provider server 30 may comprise storage repository 32, which comprises at least one computer readable storage repository module 34, which may store data corresponding to fantasy sports players available for drafting, such as player identity information, past performance statistics, future performance predictions, or other player-related data or media, for example. In another embodiment, fantasy sports service provider storage repository 32 may comprise at least one further computer readable storage repository module 36 which may store data corresponding to fantasy sports users or participants in a fantasy sport competition, such as user identities and account information, user fantasy sports player squads or picks, user points accumulated during fantasy sports play, or other user-related data or media, for example.

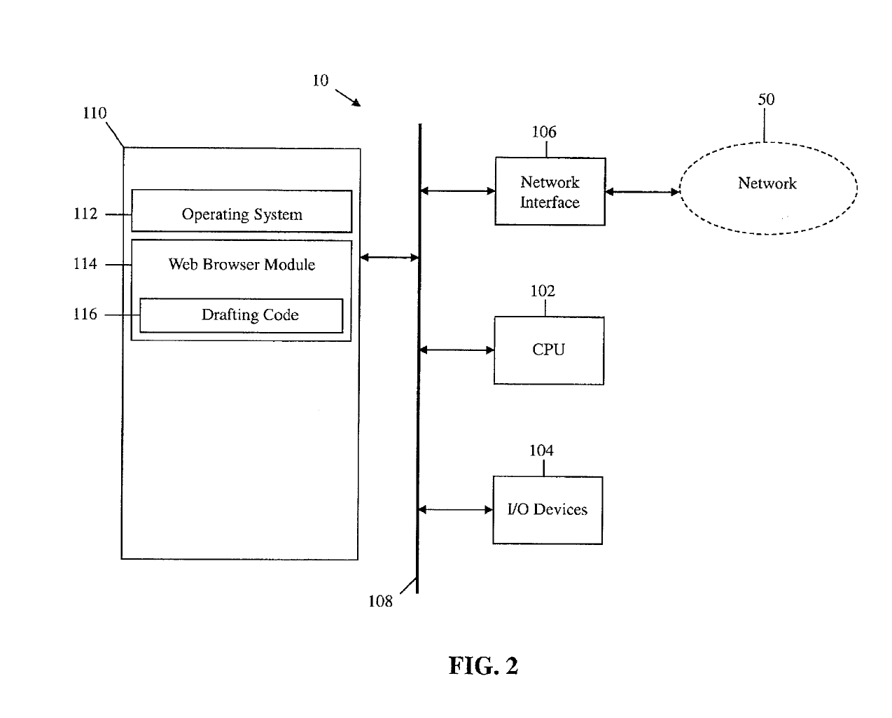

FIG. 2 illustrates a functional block diagram of an exemplary computer architecture for a user device 10 configured in accordance with an embodiment of the invention. The user device 10 may comprise any suitable user computing device such as those described above in reference to FIG. 1, and examples of which include a desktop computer, laptop or other portable computer, tablet computer, mobile device or smartphone. In one embodiment, the user device 10 includes standard computing components, including: a central processor 102, such as a general purpose processor, digital signal processor (DSP), ASIC, FPGA or other programmable logic device or processing device, or cooperating combination of processing devices; and input/output devices 104, which are linked by a bus 108. The input/output devices 104 may comprise a keyboard, buttons, keys, mouse, pointing device, touch screen, monitor, printer, and the like, for example.

A network interface 106 is also connected to the bus 108. The network interface 106 provides connectivity to a network 50, such as the exemplary computer network 50 described above, thereby allowing the user device 10 to operate in a networked environment. Also connected to the bus 108 is a computer-readable memory 110. The memory 110 stores executable instructions to implement functions of the invention. The computer-readable memory 110 may comprise any available computer-readable media or device as may be known in the art that can be accessed by the user device 10, such as but not limited to random access memory (RAM), read only memory (ROM), volatile or non-volatile storage devices, hard disk drives, optical and/or magneto-optical disks, flash memory, magnetic disks, or processor cache or multi-level hierarchical processor cache memories included in processor 102, for example.

In an embodiment of the invention, one or more of the following program modules and data files may be stored in the memory 110 of the user device 10: an operating system module 112, a web browser or fantasy sports application (app) module 114.

The operating system module 112 may comprise any known executable operating system instructions, such as may be suitable for controlling the general operations of a networked user device 10, and in particular may comprise instructions for handling various system services, such as file services or for performing hardware dependent tasks. Operating system module 112 may also comprise instructions for standard computer operation, including receiving input from input devices such as a keyboard, touchscreen or mouse, and for displaying output in a graphical format on a monitor, display or touchscreen for example. In particular embodiments, operating system module 112 may comprise one or more known proprietary or open-source computer operating systems, such as for example, Windows™, MacOS™, UNIX™, Linux™, iOS™, Android™, Blackberry™, Symbian™, Windows Phone™ operating systems.

The exemplary web browser or fantasy sports application module 114 comprises instructions for communicating with a fantasy sports draft server 20, and optionally also a fantasy sports service provider server 30, over a computer network, to transmit data to and from the user device 10, such as fantasy sports draft and competition (league) data, to be received by fantasy sports draft server 20. In one embodiment, the web browser or fantasy sports application module 114 includes exemplary fantasy sports drafting code 116 which comprises computer executable instructions for implementing a method of drafting one or more fantasy sports players according to an embodiment of the present invention. In one embodiment, web browser module 114 may comprise drafting code 116 which comprises HTML/Javascript/HTML5 data files which may comprise at least one of HTML/Javascript/HTML5 code such that the drafting code 116 comprises a software application intended for use on multiple mobile device platforms for execution by a web browser module 114 as web application instructions to implement a method of drafting one or more fantasy sports players, for example. In another embodiment, fantasy sports application (app) module 114 may comprise drafting code 116 which comprises executable instructions expressed in any suitable format for execution by the application module 114 as user device native executable instructions to implement a method of drafting one or more fantasy sports players, for example. Exemplary such computer executable instructions according to embodiments of the invention are described in further detail below.

The modules stored in memory 110 are exemplary, and additional modules can be included. It should be appreciated that the functions of the presented modules may be combined. In addition, a function of a module need not be performed on a single machine, instead, the function may be distributed across a network to one or more other computers if desired, for example. It is the functions of the invention that are significant, not where they are performed or the specific manner in which they are performed.

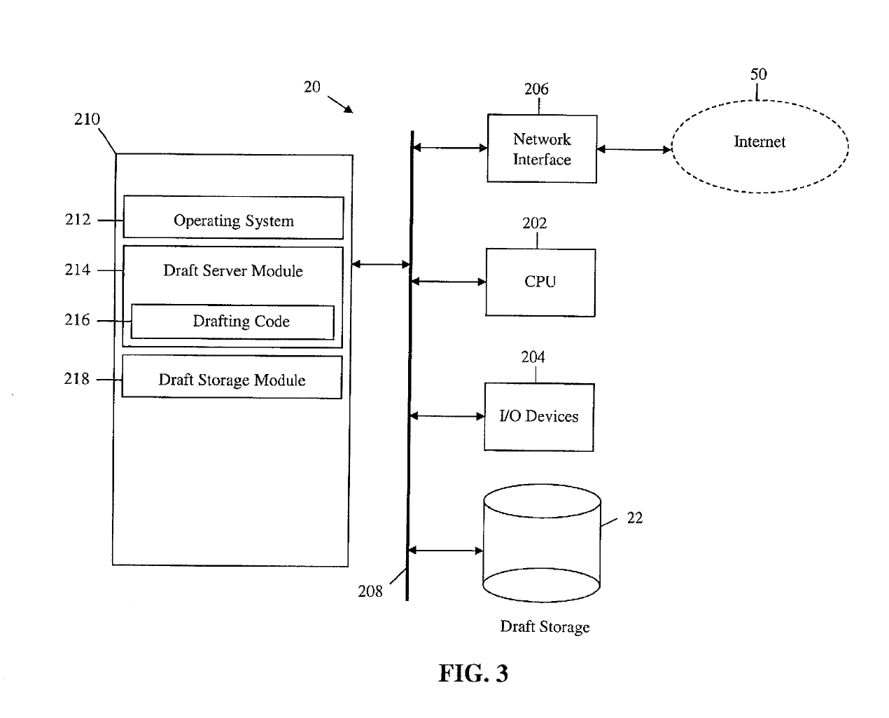

FIG. 3 illustrates a functional block diagram of an exemplary computer architecture for a fantasy sports draft server 20 configured in accordance with an embodiment of the invention. The draft server 20 may comprise any suitable server device and in one embodiment, may include standard computing components, including: a central processor 202, such as a general purpose processor, digital signal processor (DSP), ASIC, FPGA or other programmable logic or processing device, or cooperating combination of processing devices; and input/output devices 204, which are linked by a bus 208. The input/output devices 204 may comprise a keyboard, buttons, keys, mouse, pointing device, touch screen, monitor, printer, and the like, for example.

A network interface 206 is also connected to the bus 208. The network interface 206 provides connectivity to a network, such as the exemplary computer network 50 described above, thereby allowing the server 20 to operate in a networked environment. Also connected to the bus 208 is at least one computer-readable memory 210. The memory 210 stores executable instructions to implement functions of the invention. The computer-readable memory 210 may comprise any available computer-readable media or device as may be known in the art that can be accessed by the user device 10, such as but not limited to random access memory (RAM), read only memory (ROM), volatile or non-volatile storage devices, hard disk drives, optical and/or magneto-optical disks, flash memory, magnetic disks, or processor cache or multi-level hierarchical processor cache memories included in processor 202, for example.

Fantasy sports draft server 20 also comprises a draft server storage repository 22 capable of storing data transmitted to and/or received from other computers, such as user data corresponding to one or more fantasy sports user, player data corresponding to one or more fantasy sport players, and system data corresponding to one or more system function, for example. In one such embodiment, system data may comprise at least one of data corresponding to a fantasy sports game, and data corresponding to operation of the system such as control, statistical, advertising or commercial data, for example. Draft server storage repository 22 may comprise a conventional data storage device such as a hard disk or solid-state memory located with and connected directly to draft server 20 such as by bus 208 as shown in FIG. 3, or may alternately comprise a remote data storage facility accessibly connected to draft server 20.

In an embodiment of the invention, one or more of the following program modules and data files may be stored in the memory 210 of the draft server 20: an operating system module 212, a draft server module 214, and a draft storage module 218. Similar to the operating system module described above in reference to FIG. 2, the operating system module 212 may comprise instructions suitable for controlling the general operations of draft server 20, and in particular may comprise instructions for handling various system services, such as file services or for performing hardware dependent tasks. Operating system module 212 may also comprise instructions for standard computer operation, including receiving input from input devices such as a keyboard, touchscreen or mouse, and for displaying output in a graphical format on a monitor, display or touchscreen for example. In particular embodiments, operating system module 212 may comprise one or more known proprietary or open-source computer operating systems, such as, for example, Windows™, MacOS™, UNIX™, Linux™, iOS™, Android™, Blackberry™, Symbian™, Windows Phone™ operating systems.

The exemplary build server module 214 may comprise instructions for communicating with one or more user devices 10, and optionally also a fantasy sports service provider server 30, over a computer network, to transmit data to and from the draft server 20, such as fantasy sports draft and competition (league) data, to be received by user device 10. In one embodiment, the draft server module 214 includes exemplary fantasy sports drafting code 216 which comprises computer executable instructions for implementing a method of drafting one or more fantasy sports players according to an embodiment of the present invention. In one embodiment, draft server module 214 may comprise instructions for transmitting drafting code 216 which may comprise an exemplary web application, such as an HTML/Javascript/HTML5 web application to one or more user devices, such that the drafting code 216 may be used on multiple user device platforms for execution by a web browser module on the user device 10 as web application instructions to implement a method of drafting one or more fantasy sports players, for example. In another embodiment, draft server module 214 may comprise drafting code 216 which comprises executable instructions expressed in any suitable format for execution by a native executing application module on the user device 10 as native executable instructions to implement a method of drafting one or more fantasy sports players, for example. Exemplary such computer executable instructions according to embodiments of the invention are described in further detail below.

In one embodiment, memory 210 of draft server 20 may further comprise a draft storage module 218. Draft storage module 218 may comprise executable instructions to communicate with and transmit data to and from a draft server storage repository 22, as described above. In such an embodiment, such instructions may comprise computer executable instructions to implement storing of data transmitted to and/or received from other computers, such as user data corresponding to one or more fantasy sports user, player data corresponding to one or more fantasy sport players, and system data corresponding to one or more system function, for example. In one such embodiment, system data may comprise at least one of data corresponding to a fantasy sports game, and data corresponding to operation of the system such as control, statistical, advertising or commercial data, for example.

The modules stored in memory 210 are exemplary, and additional modules can be included. It should be appreciated that the functions of the presented modules may be combined. In addition, a function of a module need not be performed on a single machine, instead, the function may be distributed across a network to one or more other computers if desired, for example. It is the functions of the invention that are significant, not where they are performed or the specific manner in which they are performed.

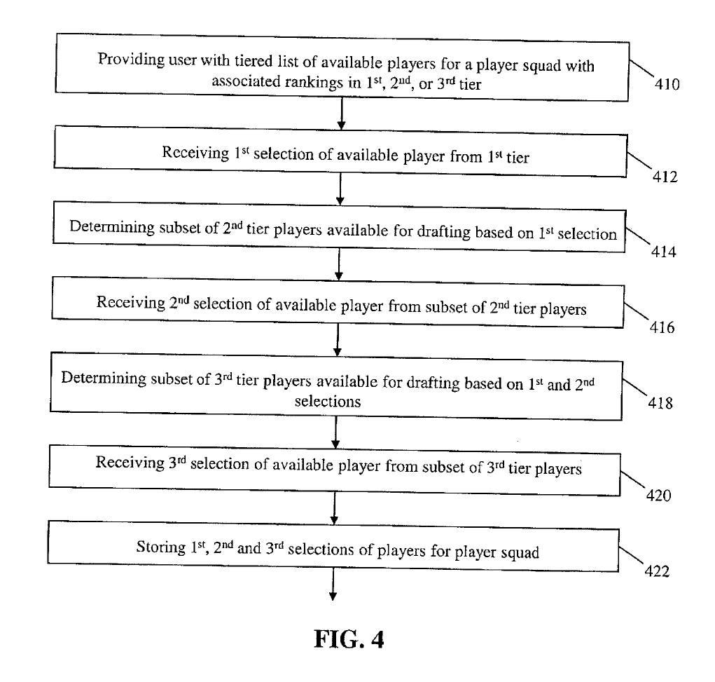

FIG. 4 illustrates an exemplary series of operations that may be implemented by the system illustrated in FIG. 1, and the exemplary user devices 10 illustrated in FIG. 2 and draft server 20 illustrated in FIG. 3, according to an embodiment of the invention. The first operation 410 of FIG. 4 comprises providing a user with a tiered list of available players for a player squad with associated rankings of the players in 1^{st}, 2^{nd} or 3^{rd} tiers. In one embodiment, the tiered list of available players and their rankings in 1^{st}, 2^{nd} or 3^{rd} tiers may be retrieved from storage repository 22 of draft server 20 such as by drafting module 214, and transmitted to user device 10, for providing to the user, such as by drafting code 116, for example. In another embodiment, the rankings of available players may be retrieved from an optional fantasy sports service provider server 30, such as by drafting module 214, for storage in draft storage repository 22 and for determining tiers in the tiered list such as by drafting module 214, for example. In a particular embodiment, the available players in the tiered list provided to the user may all correspond to a particular squad, such as a player squad for a particular position or group of positions played by each available player in a fantasy sport game. In one such example, the tiered list for a quarterback player squad for an American football fantasy sport game may comprise a list of only available ranked players who play at the quarterback position, for example. In another embodiment, the tiered list may be provided to the user in a graphical format, whereby the hierarchical tiers may be visually displayed to the player in a corresponding hierarchical order.

In one exemplary embodiment, a tiered list of available players corresponding to a given player squad or playing position, such as quarterbacks, may be provided to a user including a series of players arranged according to their predetermined hierarchical ranking, with a first tier of players provided in descending ranking order, such as players ranked 1^{st} to 5^{th}, for example, a second tier of players provided in descending ranking order, such as players ranked 6^{th} to 16^{th}, for example, and a third tier of players provided in descending ranking order such as players ranked 17^{th} to 33^{rd}, for example. In one embodiment, the predetermined ranking of players for selection to a given player squad (corresponding to playing position) may be determined by an arbitrary party, such as a fantasy sports service provider, or professional sports analysts' poll, or other arbitrary party, or in an alternative embodiment, the predetermined ranking of players may be determined by the users of the fantasy sports drafting system, for example.

The second operation 412 of FIG. 4 comprises receiving a 1^{st} selection of an available player from the 1^{st} tier. In one embodiment, the web browser or fantasy sports application 114 executing drafting code 116 on user device 10 may be used to implement operation 412 to receive the user's selection of an available player from the 1^{st} tier, such as by receiving a user input on one or more of a touchscreen, keyboard, mouse, microphone, or other input device to discern the user's selection of a player. In another embodiment, the user's 1^{st} selection of an available player in the 1^{st} tier may be transmitted from the user device 10 to be received by the draft server 20. In such an embodiment, draft server module 214 may be used to receive the user's selection on the draft server 20. In a further embodiment, the user's 1^{st} selection of an available player from the 1^{st} tier may further be temporarily cached on draft server 20 such as on draft server storage repository 22, such as by draft server storage module 218, for example.

The third operation 414 of FIG. 4 comprises determining a subset of 2^{nd} tier players available for drafting based on the user's 1^{st} selection. In one embodiment of the present invention, draft server module 214 and/or drafting code 216 executing on draft server 20 may be used to implement operation 414 to determine a subset of 2^{nd} tier players available to a user for drafting based on the user's 1^{st} selection. In an alternative embodiment, the web browser or fantasy sports draft application module 114 and/or the drafting code 116 executing on user device 10 may be used to implement operation 414. In a particular embodiment, the subset of 2^{nd} tier players which are available for drafting to a user may be determined by a generally hierarchical reverse process, whereby the higher ranked that the 1^{st} tier player selected by a user was in operation 412, the lower the rankings of the subset of 2^{nd} tier players that are available to the user for drafting in operation 414, and vice versa.

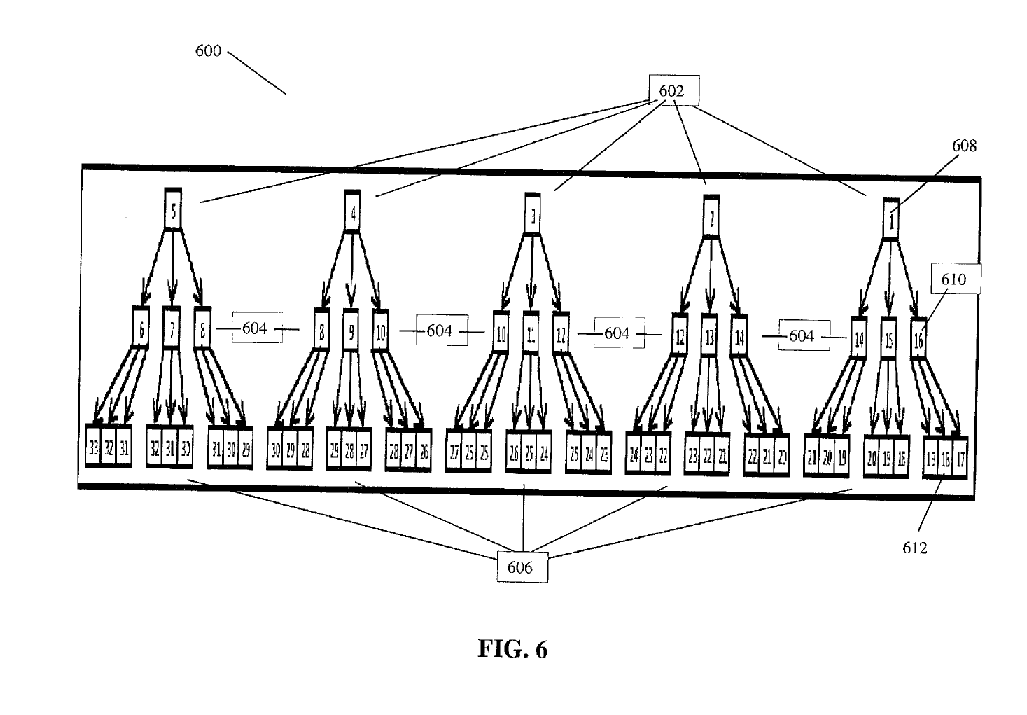

In a particular embodiment, each 1^{st} tier player available for selection by a user in operation 412 will, if selected, determine a subset of three corresponding 2^{nd} tier players available to the user for drafting in operation 414. In such an embodiment, the three available 2^{nd} tier players determined corresponding to each selected 1^{st} tier player may overlap by one player, so that the highest and lowest ranked 2^{nd} tier players, a subset of three players corresponding to a given selected 1^{st} tier player, will also be available in the subset of three 2^{nd} tier players corresponding to the next lower and next higher ranked 1^{st} tier player selected in operation 412, for example. A hierarchical ranking list comprising 1^{st}, 2^{nd} and 3^{rd} tiers corresponding to such an embodiment is illustrated in FIG. 6, as further described below. In an alternative embodiment, each subset of 2^{nd} tier players may comprise a different number of available players, such as 2, or 4, or another suitable number, dependent on the number of ranked players assigned to each tier in the predetermined ranking of players, for example.

The fourth operation 416 of FIG. 4 comprises receiving a 2^{nd} selection of an available player from the subset of 2^{nd} tier players. In one embodiment, the web browser or fantasy sports application 114 executing drafting code 116 on user device 10 may be used to implement operation 416 to receive a user's 2^{nd} selection of an available player from the subset of 2^{nd} tier players determined according to operation 414, such as by receiving a user input on one or more of a touchscreen, keyboard, mouse, microphone, or other input device to discern the user's selection of a 2^{nd} tier player. In another embodiment, the user's 2^{nd} selection of an available player from the subset of 2^{nd} tier players may be transmitted from the user device 10 to be received by the draft server 20. In such an embodiment, draft server module 214 may be used to implement receiving the user's 2^{nd} tier player selection on the draft server 20. In a further embodiment, the user's 2^{nd} selection of an available player from subset of 2^{nd} tier players may further be temporarily cached on draft server 20 such as on draft server storage repository 22, such as by draft server storage module 218, for example.

The fifth operation 418 of FIG. 4 comprises determining a subset of 3^{rd} tier players available for drafting based on the user's 1^{st} and 2^{nd} selections. In one embodiment of the present invention, draft server module 214 and/or drafting code 216 executing on draft server 20 may be used to implement operation 418 to determine a subset of 3^{rd} tier players available to a user for drafting based on the user's 1^{st} and 2^{nd} selections. In an alternative embodiment, the web browser or fantasy sports draft application module 114 and/or the drafting code 116 executing on user device 10 may be used to implement operation 418. In a particular embodiment, the subset of 3^{rd} tier players which are available for drafting to a user may be determined by a generally hierarchical reverse process, whereby the higher ranked that the 1^{st} tier and 2^{nd} tier players selected by a user in operations 412 and 414 were, the lower the rankings of the subset of 3^{rd} tier players that are available to the user for drafting in operation 418, and vice versa.

In a particular embodiment, each 1^{st} and 2^{nd} tier player available for selection by a user in operation 414 will, if selected, determine a subset of three corresponding 3^{rd} tier players available to the user for drafting in operation 418. In such an embodiment, the three available 3^{rd} tier players determined corresponding to each selected 1^{st} and 2^{nd} tier player may overlap by two players, so that the two higher and two lower ranked 3^{rd} tier players in a subset of three players corresponding to given selected 1^{st} and 2^{nd} tier players will also be available in the subset of three 3^{rd} tier players corresponding to the next lower and next higher ranked 2^{nd} tier player selected in operation 414, for example. A hierarchical ranking list comprising 1^{st}, 2^{nd} and 3^{rd} tiers corresponding to such an embodiment is illustrated in FIG. 6 as further described below. In an alternative embodiment, each subset of 3^{rd} tier players may comprise a different number of available players, such as 2, or 4, or another suitable number, dependent on the number of ranked players assigned to each tier in the predetermined ranking of players, for example.

The sixth operation 420 of FIG. 4 comprises receiving a 3^{rd} selection of an available player from the subset of 3^{rd} tier players. In one embodiment, the web browser or fantasy sports application 114 executing drafting code 116 on user device 10 may be used to implement operation 420 to receive a user's 3^{rd} selection of an available player from the subset of 3^{rd} tier players determined according to operation 418, such as by receiving a user input on one or more of a touchscreen, keyboard, mouse, microphone, or other input device to discern the user's selection of a 3^{rd} tier player. In another embodiment, the user's 3rd selection of an available player from the subset of 3^{rd} tier players may be transmitted from the user device 10 to be received by the draft server 20. In such an embodiment, draft server module 214 may be used to implement receiving the user's 3^{rd} tier player selection on the draft server 20. In a further embodiment, the user's 3^{rd} selection of an available player from subset of 3^{rd} tier players may further be temporarily cached on draft server 20 such as on draft server storage repository 22, such as by draft server storage module 218, for example.

The seventh operation 422 of FIG. 4 comprises storing the 1^{st}, 2^{nd}, and 3^{rd} selections of players for a player squad of a user. In one embodiment, draft server module 214 may be used to implement the storage of the user's 1^{st} 2^{nd} and 3^{rd} selections of players for the user's player squad. In a particular such embodiment, the user's 1^{st} 2^{nd} and 3^{rd} selections of players may be stored on draft server 20 such as more particularly on draft server storage repository 22 such as may be implemented by draft server storage module 218, for example, and may be stored in association with other information corresponding to the user, such as one or more of: user selections of players for other player squads; user account information, and user profile information relating to a fantasy sports competition or league, for example. In an alternative embodiment, web browser or fantasy sports application module 114 executing drafting code 116 on user device 10 may be used to implement operation 422, such as to store the user's 1^{st} 2^{nd} and 3^{rd} selections of players for the user's player squad on the user device, and/or to transmit and store the user's selections on draft server 20, or alternatively or additionally store the user's selections on a fantasy sports service provider server 30, for example.

In one particular embodiment of the present invention, the exemplary method may comprise only operations 410, 412, 414 and 416 and 422. In such an embodiment, the tiered list of available players provided in operation 410 may comprise only first and second tiers, such that operations 412 and 416 comprise the selection of players available to the user from the first and second tiers of the tiered list. Accordingly in such an embodiment, operation 422 comprises storing the first and second selections of players for the player squad.

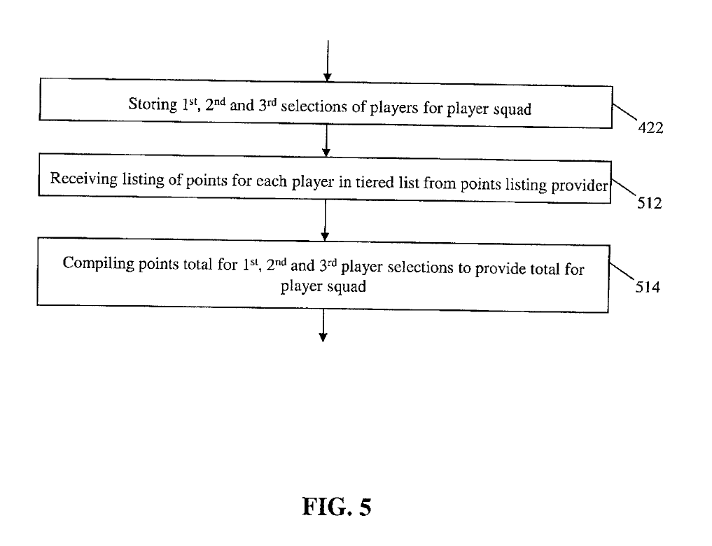

FIG. 5 illustrates an exemplary series of operations that may be implemented by the exemplary system illustrated in FIG. 1, and the exemplary user devices 10 illustrated in FIG. 2 and draft server 30 illustrated in FIG. 3, according to a further embodiment of the invention. The first operation 422 of FIG. 5 is also the seventh operation 422 of FIG. 4 and comprises storing the 1^{st}, 2^{nd}, and 3^{rd} selections of players for a player squad of a user, as described in detail above with reference to FIG. 4.

The second operation 512 of FIG. 5 comprises receiving a listing of points for each player in a tiered list from a points listing provider (not shown). In one embodiment, the draft server module 214 and/or drafting code 216 executing on draft server 20 may be used to implement operation 512 to receive a listing of points for each player in a tiered list from a points listing provider. In one such embodiment, draft server module 214 may be used to connect to a points listing provider such as over network 50 to receive a listing of points for each player in a tiered list of players. In a particular such embodiment, fantasy sports service provider server 30 may be used as a points listing provider to provide a listing of points for each player in the tiered list, or alternatively, service provider server 30 may comprise a points listing obtained from another third party points listing provider. In a further embodiment, draft server 20 may store a listing of points obtained from a points listing provider, and draft server module 214 and/or draft storage module 218 may be used to implement operation 512. In yet another embodiment, web browser or fantasy sports application module 114 and/or drafting code 116 executing on user device 10 may also or alternatively be used to implement operation 512, such as to contact a points listing provider directly, such as fantasy sports service provider server 30, or alternatively to receive a listing of points from a points listing provider from draft server 20, for example.

The third operation 514 of FIG. 5 comprises compiling a points total for the 1^{st}, 2^{nd}, and 3^{rd} player selections to provide a total for the player squad. In one embodiment, the draft server module 214 and/or drafting code 216 executing on draft server 20 may be used to implement operation 514 to compile a points total for the 1^{st}, 2^{nd} and 3^{rd} player selections made by a user to provide a points total for the user's player squad, such as by compiling the individual points for each selected player from the listing of points. In an alternative embodiment, fantasy sports service provider server 30 may receive a list of player selections, and may be used to implement operation 514 to compile the points total for the user's 1^{st}, 2^{nd} and 3^{rd} player selections. In another embodiment, web browser or fantasy sports application module 114 and/or drafting code 116 executing on user device 10 may also or alternatively be used to implement operation 514 to compile the points total for the user's player selections, and to provide a total of points for the user's player squad. Following the compilation of points total for a user's player squad, the points total can be used to compare the user's squad against another user's squad, such as for the purposes of relative scoring of players in a fantasy sports competition or league, for example.

FIG. 6 illustrates an exemplary tiered draft selection tree 600, showing a plurality of potential selection paths for drafting players in a fantasy sport game according to an embodiment of the invention. Draft selection tree 600 comprises three exemplary tiers of ranked players, and shows one exemplary arrangement of rankings and available selection paths and player subsets according to an embodiment of the invention. The first tier of rankings comprises the top 5 player rankings 602 from which a user may select a 1^{st} selected player. For each of the top 5 rankings 602 in the top tier, a corresponding subset of three 2^{nd} tier rankings 604 are available for selection by a user of a 2^{nd} tier selection. Similarly, for each of the 6^{th} to 16^{th} rankings 604 in the 2^{nd} tier, a corresponding subset of three 3^{rd} tier rankings 606 are available for selection by a user of a 3^{rd} tier selection. In one exemplary embodiment, a user may select the 1^{st} ranking 608 in the 1^{st} tier, and may then select a 2^{nd} tier ranking from the subset of the 14^{th}, 15^{th} and 16^{th} rankings shown in the selection path leading from the 1^{st} ranking 608, which are the hierarchically lowest ranking subset in the 2^{nd} tier to correspond to the highest 1^{st} tier ranking. If the user then selects the 16^{th} ranking 610 for their 2^{nd} tier selection, the user may then select a 3^{rd} tier ranking from the subset of the 17^{th}, 18^{th} and 19^{th} rankings 612 shown in the selection path leading from the 16^{th} ranking 610, which are the hierarchically highest ranking subset in the 3^{rd} tier to correspond to the lowest ranking (16^{th} ranking 610) in the 2^{nd} tier. In such a manner, the selection paths available to a user for selecting 1^{st}, 2^{nd} and 3^{rd} tier selections of ranked players allows for a desirably fair choice of ranked players for drafting to their fantasy sports player squad for any given user of the exemplary draft selection tree, regardless of how many users may use the tree in a given fantasy sports competition or league, for example.

In alternative embodiments, each tier of rankings may comprise more or fewer available rankings for selection than those shown in the exemplary embodiment shown in FIG. 6. Similarly, the number of rankings available in selection path subsets in subsequent tiers may also comprise more or fewer rankings than as shown in FIG. 6. In a general such embodiment, the first tier of the tiered list of available players may comprise the first to N^{th} ranked players, the second tier of the tiered list of available players comprises the (N+1)^{th} to (N₂=N+1+2N)^{th} ranked players, and the third tier of the tiered list of available players comprises the (N₂+1)^{th} to (N₂+2+3N)^{th} ranked players, for example.

In another embodiment, the present invention may comprise a further operation comprising receiving a selection by a user of one of an active and an inactive status for each of the first, second and third selections of players to determine which of the first, second or third selections are included in a points total for the first player squad selected by a user. In such an embodiment, a user may determine whether to “play” a selected player by selecting an active status for the player in order to include the player's points in the points total of the user's player squad, or to “bench” a selected player by selecting an inactive status for the player to exclude the player's points in the points total of the user's player squad. Accordingly, a user can simulate the decisions of a manager or coach of a sports team with regard to player selection based on expected or predicted current performance of a particular selected player.

In a further embodiment, the present invention may comprise further operations comprising: providing a user with a tiered list of available players available for drafting to the user's fantasy team for at least one second player squad, each available player having an associated ranking in a first, second or third tier of the tiered list; and receiving first, second and third selections of first, second and third available players for the second player squad from a first, a subset of the second, and a subset of the third tier of available players. In such an embodiment, multiple player squads may be selected by a user, such as corresponding to multiple player positions played in a fantasy sport. In one such example wherein the fantasy sport comprises North American football, multiple player squads may be selected by a user corresponding to football positions selected from the list comprising: quarterback; running back; wide receiver; tight end; defensive line; line backer; defensive back; and kicker, for example.

In yet a further embodiment, the present invention may comprise further operations comprising: providing a second user with a tiered list of available players available for drafting to the second user's fantasy team for a first player squad, each available player having an associated ranking in a first, second or third tier of the tiered list; receiving first, second and third selections of first, second and third available players for the first player squad for the second user from the first, a subset of the second and a subset of the third tier of available players; and storing first, second and third selections of players for the player squad for the second user. In such an embodiment, multiple users may simultaneously, or separately select player squads so as to enable competition in the same fantasy sports competition or league, for example. In a particular exemplary embodiment, the present invention may also comprise providing each user with historical scoring information about at least one of the first, second and third selections of first, second and third available players for their player squads, such as to provide the users with insight or “scouting” information about the available and their selected players, to improve a user's ability to make predictions of expected player performance to inform their selection of available players to their player squad.

In an alternative embodiment of the present invention, a system for drafting one or more players in a fantasy sport may be provided, where the system comprises: one or more network interfaces, at least one processor, a computer-readable memory module, and computer readable instructions stored in the computer-readable memory module. In such an embodiment, when the computer-readable instructions are executed, they are operable to cause the at least one processor to: provide a user with a tiered list of available players available for drafting to the user's fantasy team for a player squad, each available player having an associated ranking in a first, second or third tier of the tiered list; receive a first selection of a first available player for the first player squad from the first tier of available players; determine a subset of the second tier of available players available to the user for drafting in the second tier, based on the first selection; receive a second selection of a second available player for the player squad from the subset of the second tier of available players; determine a subset of the third tier of available players available to the user for drafting in the third tier, based on the first and second selections; receive a third selection of a second available player for the player squad from the subset of the third tier of available players; and store the first, second and third selections of players for the player squad. In further such embodiments, the system may also provide for selection of players by multiple users, and for multiple player squads, for example.

While the present invention and its various functional components and operational functions have been described in particular exemplary embodiments, the invention may also be implemented in hardware, software, firmware, middleware or a combination thereof and utilized in systems, subsystems, components or subcomponents thereof. In particular embodiments implemented in software, elements of the present invention may be instructions and/or code segments to perform the necessary tasks. The program or code segments may be stored in a machine readable medium, such as a processor readable, such as a processor readable medium or a computer program product, or transmitted by a computer data signal embodied in a carrier wave, or a signal modulated by a carrier, over a transmission medium or communication link. The machine readable medium or processor readable medium may include any medium that can store or transfer information in a form readable and executable by a machine, for example a processor, computer, etc.

An embodiment of the present invention relates to a computer storage product with a computer-readable medium having computer code thereon for performing various computer-implemented operations. The computer-readable media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (“ASICs”), programmable logic devices (“PLDs”) and ROM and RAM devices including Flash RAM memory storage cards, sticks and chips, for example. Examples of computer code include machine code, such as produced by a compiler, and files containing higher-level code that are executed by a computer using an interpreter. For example, an embodiment of the invention may be implemented using HTML, HTML5, XML, JavaScript, Java, C#, C++, Objective C, or other scripting, markup and/or programming languages and development tools. Another embodiment of the invention may be implemented in hardwired circuitry in place of, or in combination with, machine-executable software instructions.

The exemplary embodiments herein described are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method of drafting one or more players in a fantasy sport, the method comprising:
providing a user with a tiered list of available players available for drafting to the user's fantasy team for a player squad, each available player having an associated ranking in a first, second or third tier of the tiered list;
receiving a first selection of a first available player for the player squad from the first tier of available players;
determining a subset of the second tier of available players available to the user for drafting in the second tier, based on the first selection;
receiving a second selection of a second available player for the player squad from the subset of the second tier of available players; and
storing the first, and second selections of players for the player squad.

2. The method of claim 1, additionally comprising:
determining a subset of the third tier of available players available to the user for drafting in the third tier, based on the first and second selections; and
receiving a third selection of a second available player for the player squad from the subset of the third tier of available players, immediately preceding said storing operation;
and wherein said storing comprises storing the first, second and third selections of players for said player squad.

3. The method of claim 2, wherein the first tier of the tiered list of available players comprises the first to N^{th} ranked players, the second tier of the tiered list of available players comprises the (N+1)^{th} to (N₂=N+1+2N)^{th} ranked players, and the third tier of the tiered list of available players comprises the (N₂+1)^{th} to (N₂+2+3N)^{th} ranked players.

4. The method of claim 2, wherein the first tier of the tiered list of available players comprises the first to fifth ranked players, the second tier of the tiered list of available players comprises the sixth to sixteenth ranked players, and the third tier of the tiered list of available players comprises the seventeenth to thirty-third ranked players.

5. The method of claim 2, wherein rankings of the subset of the second tier of available players available to the user for drafting in the second tier are based on the ranking of the first available player selected in the first selection, and wherein rankings of the subset of the third tier of available players available to the user for drafting in the third tier are based on the ranking of the first and second available players selected in the first and second selections.

6. The method of claim 2, wherein the subset of the second tier of available players available to the user for drafting in the second tier comprises three available players, and wherein the subset of the third tier of available players available to the user for drafting in the third tier comprises three available players.

7. The method of claim 2, additionally comprising:
receiving a listing of points allocated to each ranked player in the tiered list of players from a points listing provider; and
compiling a points total allocated to at least one of the first, second and third selections of players to provide a points total for the first player squad selected by a user.

8. The method of claim 2, additionally comprising:
receiving a selection by a user of one of an active and an inactive status for at least one of the first, second and third selections of players to determine which of the first, second or third selections are included in a points total for the first player squad selected by a user.

9. The method of claim 2, wherein the player squad comprises a first player squad, and additionally comprising:
providing a user with a tiered list of available players available for drafting to the user's fantasy team for at least one second player squad, each available player having an associated ranking in a first, second or third tier of the tiered list; and
receiving first, second and third selections of first, second and third available players for the second player squad from a first, a subset of the second, and a subset of the third tier of available players.

10. The method of claim 2, wherein the user comprises a first user, additionally comprising:
providing a second user with a tiered list of available players available for drafting to the second user's fantasy team for a first player squad, each available player having an associated ranking in a first, second or third tier of the tiered list;
receiving first, second and third selections of first, second and third available players for the first player squad for the second user from the first, a subset of the second and a subset of the third tier of available players; and
storing first, second and third selections of players for the player squad for the second user.

11. The method of claim 2, additionally comprising:
providing the user with historical scoring information about at least one of the first, second and third selections of first, second and third available players for the player squad.

12. The method of claim 9, additionally comprising:
storing the first, second and third selections of players for at least one second player squad; and
storing the first and second player squad selections as a team selected by the user.

13. The method of claim 2 wherein the player squad comprises a first player squad associated with a first position played by the ranked list of players in a fantasy sport.

14. The method of claim 13, wherein the fantasy sport comprises North American football, and the first position played by the ranked list of players is selected from the list comprising: quarterback; running back; wide receiver; tight end; defensive line; line backer; defensive back; and kicker.

15. A tangible, non-transitory computer-readable medium encoded with computer-executable instructions for drafting one or more players in a fantasy sport, wherein the computer-executable instructions, when executed, are operable to cause at least one processor to:
provide a user with a tiered list of available players available for drafting to the user's fantasy team for a player squad, each available player having an associated ranking in a first, second or third tier of the tiered list;
receive a first selection of a first available player for the first player squad from the first tier of available players;
determine a subset of the second tier of available players available to the user for drafting in the second tier, based on the first selection;
receive a second selection of a second available player for the player squad from the subset of the second tier of available players;
determine a subset of the third tier of available players available to the user for drafting in the third tier, based on the first and second selections;
receive a third selection of a second available player for the player squad from the subset of the third tier of available players; and
store the first, second and third selections of players for the player squad.

16. The method of claim 15, wherein the first tier of the tiered list of available players comprises the first to N^{th} ranked players, the second tier of the tiered list of available players comprises the (N+1)^{th} to (N₂=N+1+2N)^{th} ranked players, and the third tier of the tiered list of available players comprises the (N₂+1)^{th} to (N₂+2+3N)^{th} ranked players.

17. The computer-readable medium of claim 15, wherein the first tier of the tiered list of available players comprises the first to fifth ranked players, the second tier of the tiered list of available players comprises the sixth to sixteenth ranked players, and the third tier of the tiered list of available players comprises the seventeenth to thirty-third ranked players

18. The computer-readable medium of claim 15, wherein rankings of the subset of the second tier of available players available to the user for drafting in the second tier are based on the ranking of the first available player selected in the first selection, and wherein rankings of the subset of the third tier of available players available to the user for drafting in the third tier are based on the ranking of the first and second available players selected in the first and second selections

19. The computer-readable medium of claim 15, wherein the subset of the second tier of available players available to the user for drafting in the second tier comprises three available players, and wherein the subset of the third tier of available players available to the user for drafting in the third tier comprises three available players.

20. The computer-readable medium of claim 15, additionally comprising:
receiving a listing of points allocated to each ranked player in the tiered list of players from a points listing provider; and
compiling a points total allocated to at least one of the first, second and third selections of players to provide a points total for the first player squad selected by a user.

21. The computer-readable medium of claim 15, wherein the player squad comprises a first player squad, the computer-readable medium additionally comprising:
providing a user with a tiered list of available players available for drafting to the user's fantasy team for at least one second player squad, each available player having an associated ranking in a first, second or third tier of the tiered list; and
receiving first, second and third selections of first, second and third available players for the second player squad from a first, a subset of the second, and a subset of the third tier of available players.

22. The computer-readable medium of claim 15, wherein the user comprises a first user, the computer-readable medium additionally comprising:
providing a second user with a tiered list of available players available for drafting to the second user's fantasy team for a first player squad, each available player having an associated ranking in a first, second or third tier of the tiered list;
receiving first, second and third selections of first, second and third available players for the first player squad for the second user from the first, a subset of the second and a subset of the third tier of available players; and
storing first, second and third selections of players for the player squad for the second user.

23. The method of claim 15 wherein the player squad comprises a first player squad associated with a first position played by the ranked list of players in a fantasy sport, wherein the fantasy sport comprises North American football, and the first position played by the ranked list of players is selected from the list comprising: quarterback; running back; wide receiver; tight end; defensive line; line backer; defensive back; and kicker.

24. A system for drafting one or more players in a fantasy sport, the system comprising:
one or more network interfaces;
at least one processor;
a computer-readable memory module; and
computer-readable instructions stored in the computer-readable memory module, wherein the computer-readable instructions when executed, are operable to cause the at least one processor to:
provide a user with a tiered list of available players available for drafting to the user's fantasy team for a player squad, each available player having an associated ranking in a first, second or third tier of the tiered list;
receive a first selection of a first available player for the first player squad from the first tier of available players;
determine a subset of the second tier of available players available to the user for drafting in the second tier, based on the first selection;
receive a second selection of a second available player for the player squad from the subset of the second tier of available players;
determine a subset of the third tier of available players available to the user for drafting in the third tier, based on the first and second selections;
receive a third selection of a second available player for the player squad from the subset of the third tier of available players; and
store the first, second and third selections of players for the player squad.
